(19) United States
(12) Patent Application Publication
(10) Pub. No.: US 2013/0341401 A1
(43) Pub. Date: Dec. 26, 2013

(54) METHODS AND APPARATUS FOR SELECTING BARCODE SYMBOLS

(71) Applicants: Anu Kannan, New York City, NY (US); Alan J. Epshteyn, Miller Place, NY (US)

(72) Inventors: Anu Kannan, New York City, NY (US); Alan J. Epshteyn, Miller Place, NY (US)

(73) Assignee: Symbol Technologies, Inc., Holtsville, NY (US)

(21) Appl. No.: 13/533,344

(22) Filed: Jun. 26, 2012

(51) Int. Cl. G06K 7/10

(52) U.S. Cl. 235/462.08

(57) ABSTRACT

A mobile device is described. The mobile device includes a trigger control for activating an image capture function of the mobile device. An imager captures an image in the field of view of the imager upon activation of the trigger control. The image includes at least one barcode symbol. A display includes a touch screen for displaying the at least one barcode symbol. A user selects the at least one barcode symbol for decoding by contacting the touch screen at a location corresponding to a displayed location of the at least one barcode symbol.

### TECHNICAL FIELD

The present disclosure relates generally to a device and method for selecting a barcode symbol to scan and more particularly to providing a user with an image to select the barcode symbol from a plurality of barcode symbols present in the image.

### BACKGROUND

An electronic device may incorporate a variety of different input technologies. For example, the electronic device may include a keypad to allow a user to enter inputs. When data is captured by the electronic device, a further variety of different input technologies may be utilized. For example, a barcode may be associated with a plurality of digits displayed with the barcode (e.g., underneath the barcode itself). Using the keypad, the digits may be entered and the barcode associated with the digits may be retrieved. In another example, a conventional scanning device may be utilized. However, the conventional scanning device employs a physical trigger that is key based in which a cross-hair is the sole tool to pick a barcode from a field of view. Accordingly, a software trigger does not provide a selection mechanism apart from a center/in field view.

The conventional scanning device further requires the user to manually perform the data capture. Specifically, the user must hold the device, aim the device at the specific barcode to be scanned, trigger the data capture functionality, and release the device. When the conventional scanning device is stationary, the user is still required to manually position an object including the barcode in relation to the scanning device for the data capture functionality to be used. In addition, the scanning device may include a field of view to capture the data of the barcode. However, there may be times when multiple barcodes are present within the field of vision of the scanning device, thereby leading to incorrect data captures, inability to capture data, etc.

### SUMMARY

In one aspect, the invention is embodied in a mobile device. The mobile device includes a trigger control for activating an image capture function of the mobile device. An imager captures an image in the field of view of the imager upon activation of the trigger control. The image includes at least one barcode symbol. A display includes a touch screen for displaying the at least one barcode symbol. A user selects the at least one barcode symbol by contacting the touch screen at a location corresponding to a displayed location of the at least one barcode symbol.

In one embodiment, the mobile device includes a processor that decodes the at least one barcode symbol. The processor can decode the at least one barcode symbol prior to the user selecting the at least one barcode symbol. The imager can capture a plurality of barcode symbols that are displayed on the display. In one embodiment, the user can select at least two of the plurality of barcode symbols.

The trigger control can include an icon displayed on the display. A memory can store the image. An illumination component illuminates the field of view of the imager. A transceiver can be coupled to the processor for communicating with a remote device. In one embodiment, an interface can couple the mobile device to an external display. A software program executing on the processor can generate a graphical user interface (GUI) on the display.

In another aspect, the invention is embodied in a method for selecting at least one barcode symbol. The method includes capturing an image in a field of view of an imager. The image includes the at least one barcode symbol. The image including the at least one barcode symbol is displayed on a touch screen display. The at least one barcode symbol is selected by contacting the touch screen at a location corresponding to a displayed location of the at least one barcode symbol.

In one embodiment, the method further includes decoding the at least one barcode symbol. In one embodiment, the step of decoding the at least one barcode symbol occurs prior to the step of selecting the at least one barcode symbol.

The method can also include storing the image in a memory. The method can also include illuminating the field of view of the imager. The method can also include communicating with a remote device. The method can also include generating a graphical user interface (GUI) on the touch screen display. The method can also include displaying the image on a remote display.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a block diagram of the components of a mobile device according to one embodiment of the present invention.

FIG. 2 illustrates a mobile device in operation according to one embodiment of the present invention.

FIG. 3 is a flowchart of a method according to one embodiment of the present invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional touch screen technologies, need not, and are not, described in detail herein.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to a mobile device for selecting a barcode symbol to decode. The mobile device can be a mobile device having a trigger control for activating an image capture function of the mobile device. The mobile device includes an imager for capturing an image in the field of view of the imager upon activation of the trigger control. The image includes at least one barcode symbol. The mobile device also includes a display including a touch screen for displaying the at least one barcode symbol. A user selects the at least one barcode symbol by contacting the touch screen at a location corresponding to a displayed location of the at least one barcode symbol.

The exemplary embodiments describe a mobile device configured to receive a selection of a barcode symbol among a plurality of barcode symbols in an image generated within a field of view of an imager and shown on a display device. Furthermore, the mobile device can decode the selection of the barcode symbol. The mobile device, the components thereof, the image in the field of view of the imager, and related methods will be discussed in further detail below. It should be noted that the barcode symbol can be a 1-dimensional barcode symbol, a 2-dimensional barcode symbol, or a 3-dimensional barcode symbol.

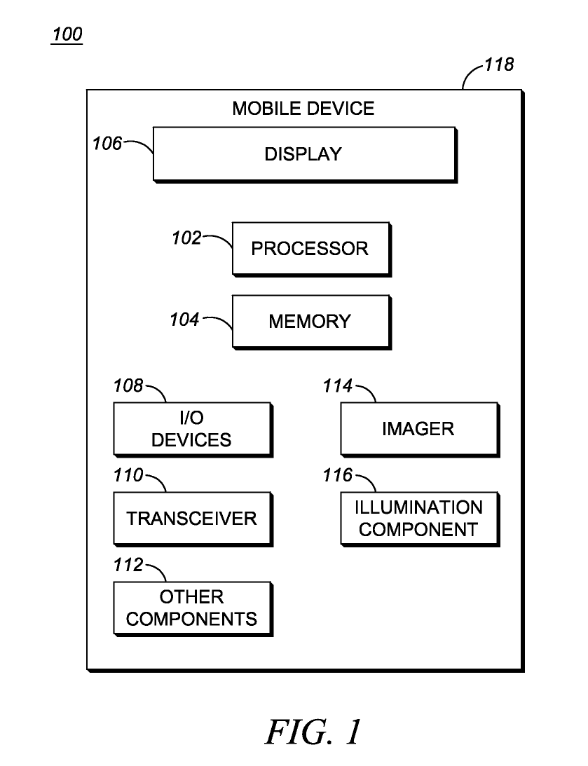

FIG. 1 is a block diagram of the components of a mobile device 100 according to one embodiment of the present invention. The mobile device 100 can be any portable device such as a mobile computer, a mobile phone, a personal digital assistant, a smartphone, a tablet, a laptop, a scanner, etc. As illustrated in FIG. 1, the mobile device 100 can include a processor 102, a memory 104, a display 106, an input/output (I/O) device 108, a transceiver 110, other components 112 such as a portable power supply (e.g., a battery), an imager 114, and an illumination component 116.

The processor 102 can provide conventional functionalities for the mobile device 100. In a specific example according to the exemplary embodiments of the present invention and as will be described in further detail below, the mobile device 100 can include a plurality of software applications that are executed on the processor 102 such as a software application related to a data capture functionality. The memory 104 can also provide conventional functionalities for the mobile device 100. For example, the memory 104 can store data and software applications related to operations performed by the processor 102.

As will be described in further detail below and in a specific example according to the exemplary embodiments of the present invention, the memory 104 can also store images including an image of a plurality of barcode symbols to be displayed. Furthermore, the memory 104 can store selections of a barcode symbol or multiple barcode symbols from the image.

The display 106 can be any component configured to display data to a user. The display 106 can include, for example, a liquid crystal display (LCD) at least partially disposed within a housing 118 of the mobile device 100. The I/O device 108 can be any component configured to receive an input from the user. For example, the I/O device 108 can be a keypad (e.g., alphanumeric keypad, numeric keypad, etc.). The I/O device 108 can also include a touch sensing pad for a user to enter inputs manually with a finger or a stylus. According to one embodiment, the display 106 can also incorporate the I/O device 108 in a touch screen configuration. For example, the I/O device 108 can be a transparent touch sensor placed over the display 106 that enables a user to enter inputs by touching the touch sensor.

The transceiver 110 can provide the mobile device 100 with a method of exchanging data with a communications network. According to another exemplary embodiment of the present invention, the image in the field of view of the imager 114 can be displayed on a display of a remote device. As such, the transceiver 110 can transmit the image data to the remote device. The remote device can also be coupled to the mobile device 100 though a hard wired connection. The other components 112 can include additional components conventionally found in electronic devices, such as a battery.

The imager 114 can be any component configured to capture image data. The imager 114 can include any type of image sensor or sensors. The imager 114 can capture an image in a field of view (FoV) of the imager 114. In one embodiment, the image captured in the FoV of the imager 114 is displayed on the display 106. It should be noted that the FoV can be a linear field, an area field, or a 3-dimensional field, depending on the configuration of the imager 114. For example, when a plurality of barcode symbols are arranged in a linear manner, the imager 114 can be positioned such that more than one barcode symbol is within a linear FoV of the imager 114. In another example, when a plurality of barcode symbols are arranged in two dimensions, the imager 114 can be positioned such that more than one barcode symbol is within the area FoV of the imager 114.

The mobile device 100 can include an illumination component 116 to illuminate an area including the FoV of the imager 114. The illumination component 116 can improve the performance of the imager 114, particularly when there is insufficient light for a suitable image to be captured.

In one embodiment, the imager 114 can generate an image in the FoV of the imager 114. In one mode of operation, the mobile device 100 including the imager 114 can be manually positioned by the user to capture a desired image. A trigger control can be activated by the user to trigger the imager 114 to capture the image. For example, the trigger control can include a control icon displayed on the display 106. Alternatively, the trigger control can embody a dedicated trigger control switch that can be used to trigger the imager 114 to capture the image.

In one embodiment, the imager 114 can automatically capture the image containing the at least one barcode symbol without user intervention. The automatic capture can be performed automatically upon the data capture functionality being initiated, or upon the imager 114 recognizing at least one barcode symbol within the FoV of the imager 114. The image captured in the FoV of the imager 114 can be displayed on the display 106.

It should be noted that the memory 104 can store a software application having an image editing functionality such that the processor 102 can execute the software application. Accordingly, the captured image displayed on the display 106 can be rotated (e.g., clockwise, counter-clockwise, etc.), flipped (e.g., horizontally, vertically, etc.), filtered, skewed, sharpened, brightened, darkened, etc. The user can modify the captured image using the software application, to make the image processing more consistent.

It should also be noted that the image editing functionality can be automatically performed prior to displaying the image on the display 106 or can be manually performed by the user by displaying a first captured image on the display 106 and then permitting the user to manipulate the image as desired.

As previously described, the display 106 can include the I/O device 108 in the form of a touch screen to enable the user to enter inputs directly on the touch screen. The processor 102 can generate a graphical user interface (GUI) on the display 106 to provide icons corresponding to certain functionality. Additionally, the GUI can illustrate locations in the image that include a barcode symbol. The GUI can also include the trigger control to activate the imager 114 for capturing the image. When the image in the FoV of the imager 114 is captured and displayed on the display 106, the user can touch the I/O device 108 (i.e., touch screen) to select a desired barcode symbol in the displayed image. The processor 102 can receive the touch input from the I/O device 108 and determine the corresponding barcode symbol selected in the image. Accordingly, the data encoded in the selected barcode symbol can be decoded. The selected barcode symbol can be decoded locally by the processor 102. Alternatively, selected barcode symbol can be decoded remotely by a remote device (not shown).

Different techniques can be employed to decode the barcode symbols contained in the captured image. In one embodiment, the mobile device 100 including the imager 114 can remain in a stationary position during the scanning process. Thus, when the user selects each barcode symbol, the imager 114 can capture a corresponding physical label on which the barcode symbol is actually disposed.

In another embodiment, the imager 114 can be configured to capture and pre-decode the barcode symbols contained in the captured image. Thus, when the user selects the desired barcode symbols, the processor 102 has already automatically decoded the barcode symbols contained in the image.

In another embodiment, the imager 114 can capture the image containing the barcode symbols and transmit the image to a remote device for processing. The remote device can include a processor that decodes the barcode symbols contained in the image. Accordingly, the processor in the remote device pre-decodes the barcode symbols in the image and transmits the data to the mobile device 100 for barcode symbol selection by the user. In one embodiment, the data can be stored in the memory 104 of the mobile device 100. Thus, when the user selects the barcode symbol, the processor 102 can retrieve the corresponding data from the memory 104.

As previously described, the mobile device 100 can include the transceiver 110 for communicating and exchanging data with other devices. According to one embodiment of the present invention, the imager 114 of the mobile device 100 can capture the image in the FoV of the imager 114. The transceiver 110 of the mobile device 100 can transmit the image data to a remote device including a display. The remote display can display the image captured by the imager 114 of the mobile device 100. That is, the image being shown on the display 106 is one embodiment. In another embodiment, the remote display may be configured with an incorporated I/O device, such as a touch screen, so that the user may touch a surface of the remote display and select a desired barcode symbol or symbols.

It should also be noted that the use of the transceiver 110 is only exemplary for this embodiment. As discussed above, the mobile device 100 can include the other components 112 including an interface (e.g., a port for receiving a first end of a cable and a port on the remote device for receiving a second end of the cable) to couple the mobile device 100 to the remote device.

The embodiments of the present invention can further be configured to decode multiple barcode symbols. As previously described, the surface on which the barcode symbol is disposed may include a plurality of barcode symbols. Thus, more than one barcode symbol can be present within the captured image. The user can select a first barcode symbol within the image using the touch screen display 106. The user can subsequently select another barcode symbol contained within the image.

In one embodiment, a software application executing on the processor 102 can prompt the user if further barcode symbols are to be selected. For example, the GUI may include a pop-up prompt that invites the user to enter a further selection. In another example, the GUI may initially inquire whether more than one barcode symbol will be selected. Thus, the GUI can provide an option for multiple selections to be made and an icon in the GUI can be used to indicate that all desired barcode symbols have been selected. In yet another example, the GUI can be preset to allow for multiple barcode symbols to be selected. Subsequently, the user can use the input to indicate that the selections are finished. Thus, even if only a single barcode symbol is selected, the user can touch the display 106 to indicate that all desired barcode symbols have been selected.

Upon receiving the selections of the barcode symbols, the processor 102 can scan and decode the data encoded in the barcode symbols using any of the above described techniques. When multiple barcode symbols are decoded, the processor 102 can capture/decode the barcode symbols using a variety of techniques. For example, a list can be generated indicating an order in which the barcode symbols are to be selected and/or decoded. Thus, the order in which the user selects the barcode symbols can indicate the order in which the barcode symbols are subsequently decoded or further processed. In another example, all selected barcode symbols can be selected and/or decoded concurrently.

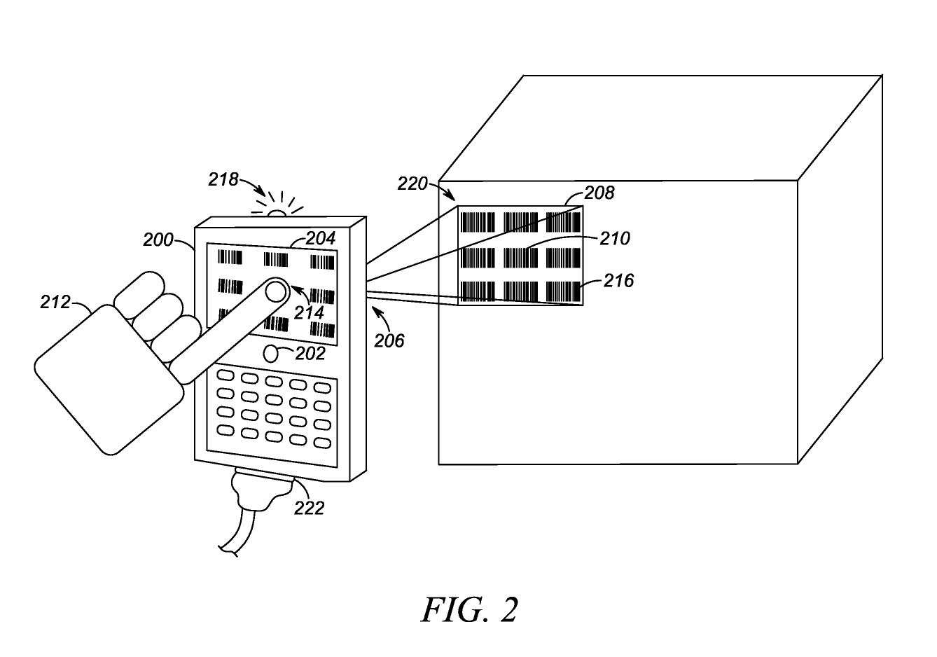

FIG. 2 illustrates a mobile device 200 in operation according to one embodiment of the present invention. The mobile device 200 can be a mobile computer having a trigger control 202 for activating an image capture function of the mobile device 200. The trigger control 202 can be a control switch, a button, a soft key, or an icon in a graphical user interface (GUI) presented on the display 204.

The mobile device 200 includes an imager 206 for capturing an image 208 in the field of view of the imager 206 upon activation of the trigger control 202. The image 208 includes at least one barcode symbol 210. The mobile device 200 also includes the touch screen display 204 including for displaying the at least one barcode symbol 210. A user 212 selects the at least one barcode symbol 210 by contacting the touch screen 204 at a location 214 corresponding to a displayed location of the at least one barcode symbol 210.

As previously described, the processor 102 (FIG. 1) of the mobile computer 200 can decode the at least one barcode symbol 210. In one embodiment, the processor 102 decodes the at least one barcode symbol 210 prior to the user selecting the at least one barcode symbol 210. In another embodiment, the imager 206 can capture a plurality of barcode symbols 210, 216 that are displayed on the display 204. The user 212 can select at least two of the plurality of barcode symbols 210, 216.

The mobile device 200 can also include an illumination source 218 for illuminating the field of view 220 of the imager 206. The mobile device 200 also includes an interface 222 for coupling the mobile device 200 to an external device (not shown).

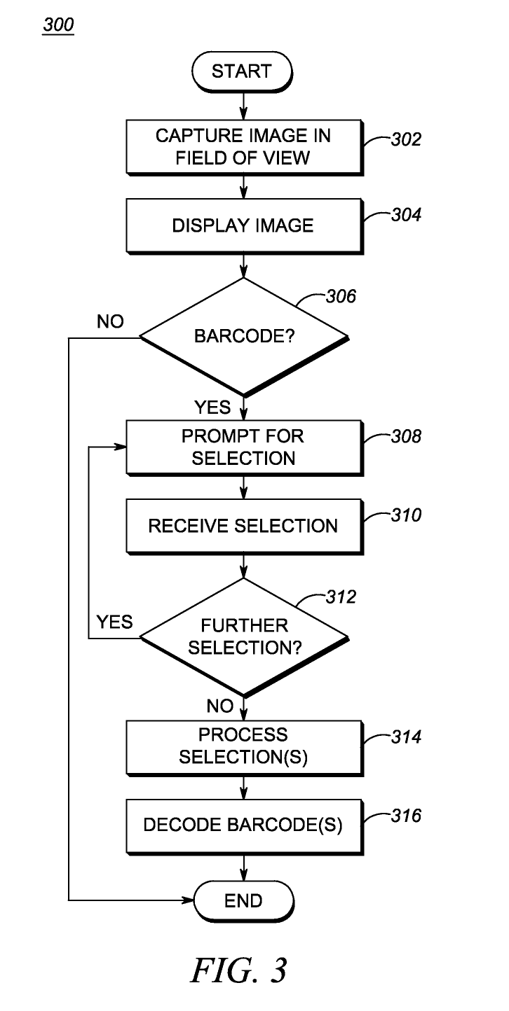

FIG. 3 is a flowchart of a method 300 according to one embodiment of the present invention. The method 300 relates to the data capturing functionality when an image in the field of view of the imager 114 is shown on the display 106 to allow the user to select a barcode symbol from a plurality of barcode symbols shown in the image. The method 300 will be described with reference to the mobile device 100 of FIG. 1.

In step 302, an image in the field of view of the imager 114 is captured. The imager 114 can include a camera, charge-coupled device (CCD), complementary metal-oxide-semiconductor (CMOS) device, or any suitable imaging device. The imager 114 can be manually aimed by the user or can be fixed to a rigid surface. The imager 114 can be triggered manually or can be automatically triggered in order to capture the image.

In addition, to improve image capturing functionality, the illumination component 116 can be used when lighting conditions are insufficient to generate an optimal image. Once the image is captured, the image is displayed on the display 106 (step 304). As previously described, the image can be displayed on the local display 106 of the mobile device 100. However, via the transceiver 110 or other communication interface, the image can be shown on a remote display of a remote device (not shown). The remote display can be a touch screen display.

In step 306, the processor 102 determines whether a barcode symbol is present in the captured image. When the imager 114 is manually aimed and triggered, it is possible that a barcode symbol is not contained in the image. When the imager 114 is automatically triggered and captures the image, there is also a possibility that no barcode symbol is contained in the captured image. Thus, the processor 102 can initially determine whether a barcode symbol is present in the captured image.

In one embodiment, the barcode symbols present in the captured image are pre-decoded by the processor 102. If a barcode symbol does not exist in the captured image, the method 300 initially ends. However, the method can be restarted and the imager 114 can capture a new image (step 302).

If the captured image contains at least one barcode symbol, the method 300 continues to step 308. In step 308, a software application executing on the processor 102 prompts the user for a selection of a desired barcode symbol. In one embodiment, step 308 can be optional and the software application executing on the processor 102 can present the image without prompting the user for a selection of a barcode symbol. In this embodiment, the software application assumes that the activation of the imager 114 and the presence of the displayed image indicate that a selection of a barcode symbol or multiple barcode symbols will be made by the user.

In step 310, the processor 102 receives the selection of the barcode symbol or symbols. As previously described, the display 106 can be configured with the I/O device 108 integrated as a touch screen. Thus, the user can provide a touch input by contacting a surface of the display 106. The touch input can provide coordinates on the captured image in which a desired barcode symbol is located. Also as previously described, the captured image may be viewed within a graphical user interface (GUI). The software application executing on the processor 102 can determine each of the locations throughout the display 106 in which a barcode symbol is present. Accordingly, the GUI can include icons or other indicators that a particular location in the captured image corresponds to a selectable barcode symbol.

In step 312, a determination can made about whether a further selection of a barcode symbol is to be made. As previously described, this determination can be achieved using a variety of techniques. In a first example, the software application executing on the processor 102 can be configured to receive multiple touch inputs for multiple selections of barcode symbols. Thus, if a first selection is received, a further selection can be received without any further prompt. If no further selection is desired, the user can indicate (e.g., via keypad, icon on GUI, etc.) that no further selection is desired.

In another example, the method 300 can return to step 308 and a prompt for another selection of a barcode image is presented on the display 106. In one embodiment, step 310 is repeated until all desired barcode symbols are selected. Once all desired barcode symbols are selected via steps 308-312, the method 300 continues to step 314 where the barcode symbols are processed. In one embodiment, the processing can include decoding the barcode symbols (step 316) to generate data for further processing. In another embodiment, one or more of the barcode symbols in the captured image are automatically decoded prior to selecting the desired barcode symbols.

It should be noted that the above described steps of the method 300 is only exemplary. The method 300 can include additional steps. For example, in one embodiment, after step 302, the method 300 can include a step of storing the image in the memory 104. In another example, after step 310, the method 300 can include a step of storing the selection in the memory 104. In a yet another example, after step 302, the method 300 can include a step of automatically decoding all barcode symbols within the captured image. Accordingly, after step 312 when all desired barcode symbols are selected, the method 300 can include a step of retrieving data encoded in the desired barcode symbols from the memory 104.

The exemplary embodiments of the present invention provide a mobile device 100 including a data capturing functionality. The mobile device 100 can include an imager 114 to generate an image of a field of view of the imager 114 to be displayed on a local display 106 and/or remote display (not shown) coupled to the mobile device 100.

The captured image can include at least one barcode symbol contained therein. The user can provide a touch input on the display 106 at locations where barcode symbols are located to indicate that the selection is a desired barcode symbol to be scanned and decoded. The data capture functionality can allow for multiple barcode symbols to be selected. The imaging and decoding of the barcode symbols contained in the image can be performed prior to the captured image being displayed for faster retrieval of the encoded data. The GUI can be used to display a captured image on the display 106 so that the user can select the desired barcode symbols.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for remotely controlling the networked camera described herein. The non-processor circuits may include, but are not limited to, a radio receiver, a radio transmitter, signal drivers, clock circuits, power source circuits, and user input devices. As such, these functions may be interpreted as steps of a method to remotely control the networked camera described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A mobile device comprising:
a trigger control for activating an image capture function of the mobile device;
an imager capturing an image in the field of view of the imager upon activation of the trigger control, the image comprising at least one barcode symbol; and
a display comprising a touch screen for displaying the at least one barcode symbol, a user selecting the at least one barcode symbol by contacting the touch screen at a location corresponding to a displayed location of the at least one barcode symbol.

2. The mobile device of claim 1 further comprising a processor that decodes the at least one barcode symbol.

3. The mobile device of claim 2, wherein the processor decodes the at least one barcode symbol prior to the user selecting the at least one barcode symbol.

4. The mobile device of claim 1, wherein the imager captures a plurality of barcode symbols that are displayed on the display, the user selecting at least two of the plurality of barcode symbols.

5. The mobile device of claim 1, wherein the trigger control comprises an icon displayed on the display.

6. The mobile device of claim 1, further comprising a memory for storing the image.

7. The mobile device of claim 1, further comprising an illumination component for illuminating the field of view of the imager.

8. The mobile device of claim 1, further comprising a transceiver coupled to the processor for communicating with a remote device.

9. The mobile device of claim 1, further comprising an interface for coupling the mobile device to an external display.

10. The mobile device of claim 1, further comprising a software program executing on the processor that generates a graphical user interface (GUI) on the display.

11. A method for selecting at least one barcode symbol, the method comprising:
capturing an image in a field of view of an imager, the image comprising the at least one barcode symbol;
displaying the image including the at least one barcode symbol on a touch screen display; and
selecting the at least one barcode symbol by contacting the touch screen at a location corresponding to a displayed location of the at least one barcode symbol.

12. The method of claim 11 further comprising decoding the at least one barcode symbol.

13. The method of claim 12, wherein the step of decoding the at least one barcode symbol occurs prior to the step of selecting the at least one barcode symbol.

14. The method of claim 11, further comprising storing the image in a memory.

15. The method of claim 11, further comprising illuminating the field of view of the imager.

16. The method of claim 11, further comprising communicating with a remote device.

17. The method of claim 11, further comprising generating a graphical user interface (GUI) on the touch screen display.

18. The method of claim 11, further comprising displaying the image on a remote display.

19. A mobile device comprising:
a control for activating an image capture function of the mobile device;
means for capturing an image upon activation of the control, the image comprising the at least one barcode symbol;
means for displaying the image including the at least one barcode symbol on a touch screen display; and
means for selecting the at least one barcode symbol by contacting the touch screen at a location corresponding to a displayed location of the at least one barcode symbol.

20. The mobile device of claim 19, further comprising means for decoding the at least one barcode symbol prior to the means for selecting the at least one barcode symbol.
